(19) United States
(12) Patent Application Publication
(10) Pub. No.: US 2023/0393874 A1
(43) Pub. Date: Dec. 7, 2023

(54) EFFICIENT PAGEFAULTS FOR VIRTUAL MACHINES

(71) Applicant: Red Hat, Inc., Raleigh, NC (US)

(72) Inventors: Michael Tsirkin, Yokneam Illit (IL); Andrea Arcangeli, Imola (IT)

(21) Appl. No.: 17/830,646

(22) Filed: Jun. 2, 2022

(51) Int. Cl. G06F 9/455; G06F 12/1009

(52) U.S. Cl. CPC G06F 9/45558; G06F 12/1009; G06F 2009/45583

(57) ABSTRACT

Systems and methods for enabling efficient communication between the hypervisor and the virtual machine to reduce the transition events between the virtual machine and the hypervisor. An example method may include: identifying, by a hypervisor running on a host computer system, a guest memory page referenced by a guest memory page address in a guest memory space of a virtual machine managed by the hypervisor; making the guest memory page inaccessible by the virtual machine; notifying the virtual machine of the guest memory page address; and responsive to receiving, from the virtual machine, a page fault notification with respect to the guest memory page, mapping a host memory page to the guest memory page.

### TECHNICAL FIELD

The present disclosure is generally related to virtualization in a computing environment, and more particularly, to virtualization technology that enhances efficient communication between a virtual machine and a hypervisor to reduce the execution to transition between the virtual machine to the hypervisor.

### BACKGROUND

Virtualization allows multiplexing of an underlying host machine between different virtual machines. The virtualization is commonly provided by a hypervisor (e.g., virtual machine monitor (VMM)) and enables the hypervisor to allocate a certain amount of a host system's computing resources to each of the virtual machines. Each virtual machine is then able to configure and use virtualized computing resources (e.g., virtual processors) to execute executable code of a guest operating systems. A host machine can accommodate more virtual machines than the size of its physical memory allows, and give each virtual machine the impression that it has a contiguous address space, while in fact the memory used by the virtual machine may be physically fragmented and even overflow to disk storage.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a high-level block diagram of an example computing system that enables a hypervisor and a virtual machine managed by the hypervisor to efficiently communicate regarding a hardware event to reduce transition events, in accordance with one or more aspects of the present disclosure;

FIG. 2 depicts a block diagram illustrating components and modules of an example hypervisor, in accordance with one or more aspects of the present disclosure;

FIG. 3 depicts a block diagram illustrating components and modules of an example virtual machine, in accordance with one or more aspects of the present disclosure;

FIG. 4 depicts a flow diagram of an example method for enabling a hypervisor to efficiently communicate with a virtual machine to reduce the transition events between the hypervisor and the virtual machine, in accordance with one or more aspects of the present disclosure;

FIG. 5 depicts a flow diagram of another example method for enabling a virtual machine to efficiently communicate with a hypervisor to reduce the transition events between the hypervisor and the virtual machine, in accordance with one or more aspects of the present disclosure;

FIG. 6 depicts a block diagram of an example computer system in accordance with one or more aspects of the present disclosure;

FIG. 7 depicts a block diagram of an illustrative computing device operating in accordance with the examples of the present disclosure.

### DETAILED DESCRIPTION

Modern computer systems that support hardware virtualization may provide a communication channel between a virtual machine and the hypervisor by using page faults. Page faults are a common occurrence in computer systems and may occur during normal operation when a virtual machine attempts to access a memory page that is not currently loaded in host physical memory. The page fault may be generated by a processor executing the virtual machine and may be handled by the hypervisor. The hypervisor may handle the page fault by loading the data into physical memory from a backing store. Page faults are typically handled transparent to the virtual machine and the virtual machine may be unaware that the page fault occurred or was handled by the hypervisor. For example, the virtual machine may execute an instruction and it may access a memory page and appear to execute successfully, but the instruction may cause a page fault and result in the virtual machine temporarily yielding execution control to the hypervisor (e.g., via a VM Exit hardware event). The hypervisor may handle the page fault by making the memory page accessible to the virtual machine. After managing the loading of the data from backing store, the hypervisor may restart the execution of the virtual machine (e.g., by executing VM Enter instruction).

During standard operation, the physical processor may transition execution back-and-forth between the virtual machine and hypervisor. Each transition may involve resource intensive operations that introduce overhead to the virtualization and may adversely affect the performance and/or efficiency of the computing system. In the example discussed above, the hardware event (e.g., page fault) may trigger a transition made from virtual machine currently running to the hypervisor, and after a control execution by the hypervisor in response to the hardware event, a transition back from the hypervisor to the virtual machine may be performed, causing multiple transitions in response to the hardware event and leading to a significant performance degradation.

Aspects of the present disclosure address the above and other deficiencies by providing technology that enables efficient communication between the hypervisor and the virtual machine to reduce the number of transitions between the virtual machine and the hypervisor. An example method may involve a pre-notification manner to communicate between the hypervisor and the virtual machine regarding a page fault. The hypervisor may scan periodically the memory of one or more virtual machines and detect a memory page that has not been accessed by the virtual machine for a while. The hypervisor may block the access to the memory page and notify the virtual machine to stop attempting using the memory page, for example, by writing guest memory page address into a communication channel in a memory space that is accessible by the hypervisor and the virtual machine. This notification can be done without interrupting the operations in the virtual machine, for example, by a host CPU that is distinct from the vCPU executing the virtual machine. After receiving the notification, the virtual machine may make the guest memory page inaccessible by application(s) running on the virtual machine by unmapping the guest memory page with the applications(s). In such a way, when a page fault is triggered by application(s)′ request to access the guest memory page, the page fault would trigger with the virtual machine instead of the hypervisor. Specifically, upon receiving application(s)′ request to access the guest memory page, the virtual machine may detect the page fault with respect to the guest memory page and notify the hypervisor of the page fault with respect to the guest memory page, for example, by writing the guest memory page address into the communication channel. After receiving the page fault notification with respect to the guest memory page, the hypervisor may map a host memory page to the guest memory page. The virtual machine may then make the guest memory page accessible by the application(s), for example, by modifying the guest page table. This enables the hypervisor and the virtual machine to reduce the transition events (e.g., VM Exit, VM Enter) through notifications between the hypervisor and the virtual machine regarding a hardware event that may trigger the transition events and making the accessibility (e.g., through mapping or unmapping) to a memory page according to the notifications. Avoidance of transition events further helps to avoid the swap in/out operations that can be caused by the transition events.

The systems and methods described herein include technical improvements to virtualization technology. In particular, aspects of the present disclosure may enhance the ability of the hypervisor and the virtual machine to reduce the number of transitions between the hypervisor and the virtual machine. This may enable the hypervisor and the virtual machine to more efficiently deal with hardware event and to take actions to enhance the operation of the virtualized environment. In another aspect, the present disclosure may enable the actions to be performed by the hypervisor and the virtual machine in a more resource efficient manner. In one example, handling a page fault may be performed by the hypervisor and the virtual machine using a pre-notification manner and the correction of the page fault may be performed using re-mapping the addresses before occurrence of a transition event. The avoidance of the transition events may involve saving additional overhead to transition data to and from a backing store. In another example, the notification between the hypervisor and the virtual machine may allow uninterrupted operations of the virtual machine. Enhancing the ability and efficiency of the hypervisor and the virtual machine may improve the virtualization technology. The enhancement may enable a computing system to reduce the amount of computing resources consumed by a set of virtual machines or enable the computing system to support an increased number of virtual machines using the same amount of computing resources.

Aspects of the present disclosure may also enhance the support of user space drivers and nested virtualization which further optimize the performance, security, and efficiency of a host computer system. A user space driver may be a device driver that is executed by a virtual machine as a user space process without kernel privileges. User space processes often have limited access to communicate with the hypervisor via hypercalls and the communication channel discussed herein may enable more optimized communication with the hypervisor. Nested virtualization may also benefit by the technology disclosed herein and typically involves a host machine that provides multiple layers of virtualization. The multiple layers may include one or more hardware virtualization layers (e.g., virtual machines), operating system virtualization layers (e.g., containers), other virtualization layers, or a combination thereof. For example, a top level virtual machine may be executed within a lower level virtual machine and the lower level virtual machine may be managed by a hypervisor. The communication channel discussed herein may enable the top level virtual machine to directly signal the hypervisor without signaling the lower level virtual machine (e.g., skip the intermediate virtual machine).

Various aspects of the above referenced methods and systems are described in details herein below by way of examples, rather than by way of limitation. The examples provided below discuss the technology above applied to a host machine that implements hardware virtualization. In other examples, the technology discussed herein may be applied generally to enable a user space driver to use a communication channel to interact with a kernel of a machine and the machine may or may not provide hardware level virtualization. Therefore, the systems and methods described herein represent improvements to the functionality of general purpose or specialized computing devices operating a virtualized environment with one or more virtual processors.

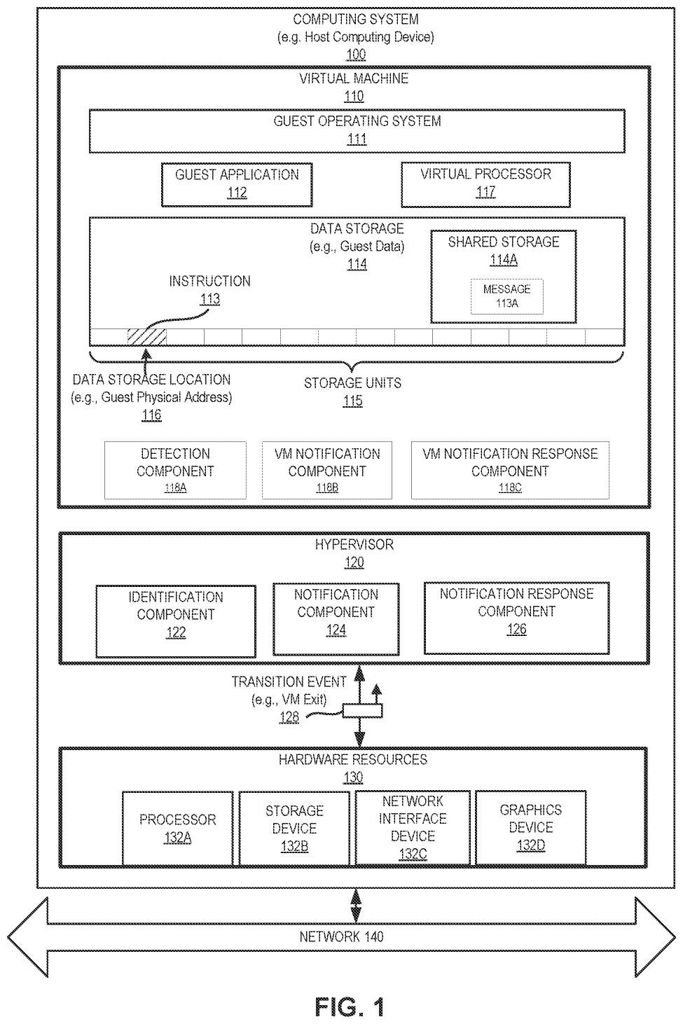

FIG. 1 depicts an illustrative architecture of elements of a computing system 100, in accordance with an embodiment of the present disclosure. Computing system 100 may be a single host machine or multiple host machines arranged in a heterogeneous or homogenous group (e.g., cluster) and may include one or more rack mounted servers, workstations, desktop computers, notebook computers, tablet computers, mobile phones, palm-sized computing devices, personal digital assistants (PDAs), etc. It should be noted that other architectures for computing system 100 are possible, and that the implementation of a computing system utilizing embodiments of the disclosure are not necessarily limited to the specific architecture depicted. In one example, computing system 100 may be a computing device implemented with x86 hardware. In another example, computing system 100 may be a computing device implemented with PowerPC®, SPARC®, or other hardware. In the example shown in FIG. 1, computing system 100 may include a virtual machine 110, a hypervisor 120, hardware resources 130, and a network 140.

Virtual machine 110 may execute guest executable code that uses an underlying emulation of physical resources. Virtual machine 110 may support hardware emulation, full virtualization, para-virtualization, operating system-level virtualization, or a combination thereof. The guest executable code may include a guest operating system 111, a guest application 112, guest device drivers, etc. Virtual machine 110 may execute one or more different types of guest operating system 111, such as Microsoft®, Windows®, Linux®, Solaris®, etc. Guest operating system 111 may manage the computing resources of virtual machine 110 and manage the execution of one or more computing processes.

A computing process may comprise one or more streams of execution for executing instructions. The stream of execution may include a sequence of instructions that can be executed by one or more processing devices (e.g., physical or virtual processors). The computing process may be managed by a kernel of guest operating system 111, hypervisor 120, a host operating system (not shown), or a combination thereof. Multiple computing processes may be executed concurrently by a processing device that supports multiple processing units. The processing units may be provided by multiple processors or from a single processor with multiple cores or a combination thereof. A computing process may include one or more computing threads, such as a system thread, user thread, or fiber, or a combination thereof. A computing process may include a thread control block, one or more counters, and a state (e.g., running, ready, waiting, start, done). In one example, a computing process may be an instance of a computer program (e.g., guest application 112) that is being executed by a virtual processor 117 and may execute an instruction 113.

Virtual processor 117 may be virtual devices capable of accessing and executing instructions within data storage 114. The instructions may encode arithmetic, logical, or I/O instructions and may be the same or similar to instruction 113. Virtual processor 117 may represent a portion of an underlying physical processor present in computing system 100 (e.g., processor 132A) or may be partially or fully emulated by hypervisor 120. Virtual processor 117 may appear to be single core processors, which may be capable of executing one instruction at a time (e.g., single pipeline of instructions) or appear to be a multi-core processor, which may simultaneously execute multiple instructions. In one example, virtual processor 117 may be a virtual central processing units (vCPU).

Instruction 113 may be an instruction that executes as part of a computing process executed by the respective virtual machine. Instruction 113 may include any form of executable code that is capable of being executed by a virtual processor 117 or physical processor 132A of computing system 100. Instruction 113 may include one or more instructions, operations, commands, machine code, operation codes (e.g., opcodes), binary code, other executable code, or a combination thereof. Instruction 113 may comply with an interface of the computing system 100. The interface may be a shared boundary between different devices, components, module, other feature, or a combination thereof. Instruction 113 may be a hardware instruction for a hardware interface provided by virtual processor 117. The hardware interface may comply with a standardized or proprietary instruction set architecture (ISA) of the virtual or physical processor. Instruction 113 may be stored within data storage 114 at one or more data storage locations 116. In one example, instruction 113 may be a particular instruction associated with guest application 112 and invoke a page fault that signals the hypervisor to perform a particular task

Data storage 114 may be data storage that is allocated by hypervisor 120 for use by virtual machine 110. Guest operating system 112 may organize and configure data storage 114 into one or more storage units 115. Storage units 115 may be logical or physical units of data storage for storing, organizing, or accessing data. A storage unit may include a contiguous or non-contiguous sequence of bytes or bits. In one example, a storage unit may be a virtual representation of underlying physical storage units, which may be referred to as physical storage blocks. Storage units 115 may have a unit size that is the same or different from a physical block size provided by an underlying hardware resource. The block size may be a fixed-size, such as a particular integer value (e.g., 4 KB, 4 MB, 1 GB) or may be a variable-size that varies within any range of integer values.

Storage units 115 may include volatile or non-volatile data storage. Volatile data storage (e.g., non-persistent storage) may store data for any duration of time but may lose the data after a power cycle or loss of power. Non-volatile data storage (e.g., persistent storage) may store data for any duration of time and may retain the data beyond a power cycle or loss of power. In one example, storage units 115 may be a memory segment and each memory segment may correspond to an individual memory page, multiple memory pages, or a portion of a memory page. In other examples, each of the storage units 115 may correspond to a portion (e.g., block, sector) of a mass storage device (e.g., hard disk storage, solid state storage). In either example, a particular portion of data storage 114 may be identified using a data storage location 116.

Data storage location 116 may include identification data that indicates a particular location in data storage 114 that stores instruction 113. The identification data of the data storage location 116 may include numeric or non-numeric data that enables computing system 100 to locate the instruction within data storage of the virtual machine. Data storage location 116 may indicate one or more locations in data storage 114 and each of the locations may include instruction 113. Data storage location 116 may include a memory location in the form of a memory address. The memory address may be a virtual address, a logical address, a physical address, other address, or a combination thereof. The memory address may correspond to any address space of virtual machine 110, guest operating system 111, hypervisor 120, host operating system (not shown), or a combination thereof. In one example, data storage location 116 may be a guest virtual memory address that corresponds to an address of a memory page in virtual memory of guest operating system 112. In another example, data storage location 116 may be a memory address of the virtual machine that identifies a memory location that is perceived by the virtual machine to be a physical memory address but is actually a logical location provided by or emulated by the hypervisor (e.g., pseudo-physical address).

As shown in FIG. 1, data storage 114 may include shared storage 114A. Shared storage 114A may be accessible by the virtual machine 110 and the hypervisor 120. In one example, a message 113A may be an instruction for the communication between virtual machine 110 and hypervisor 120 as discussed in more detail below. In the example shown, the share storage 114A may be utilized by the virtual machine 110 for establishing a communication channel and the virtual machine 110 may include a detection component 118A, a VM notification component 118B, and a VM notification response component 118C. The components discussed herein are purely logical, and one or more components can be implemented by one or more hardware and/or one or more software modules.

Components 118A, 118B, and 118C may enable virtual machine 110 to communicate with hypervisor 120 regarding a hardware event by implementing a communication channel to avoid transition events. Each of the components may be separated into one or more components or may be included within the same component. Detection component 118A may detect the occurrence of a hardware event for data storage and determine whether the hardware event includes a page fault with virtual machine caused by the access attempt to the memory page from the guest application. The page fault with virtual machine may correspond to a memory page that is upmapped with a guest memory that does not reside in physical memory. VM notification component 118B may enable virtual machine 110 to receive information of the memory page involved in the page fault with virtual machine and generate a second message to the hypervisor 120. The second message may indicate that access to the memory page involved in the page fault with virtual machine is desired and notify the hypervisor to make the memory page accessible by guest application running on the virtual machine. VM notification response component 118C may enable the virtual machine 110 to detect the first message provided by the hypervisor 120 and, in response to the first notification message, make the candidate memory inaccessible by the guest application running on the virtual machine 110.

Hypervisor 120 may also be known as a virtual machine monitor (VMM) and may provide one or more virtual machines 110 with direct or emulated access to hardware resources 130. In the example shown, hypervisor 120 may run directly on the hardware of computing system 100 (e.g., bare metal hypervisor). In other examples, hypervisor 120 may run on or within a host operating system (not shown). Hypervisor 120 may manage system resources, including access to hardware resources 130. Hypervisor 120, though typically implemented as executable code, may emulate and export a bare machine interface to higher-level executable code in the form of virtual processor 117 and data storage 114 (e.g., guest memory). Higher-level executable code may comprise a standard or real-time operating system (OS), may be a highly stripped down operating environment with limited operating system functionality and may not include traditional OS facilities, etc. Hypervisor 120 may support any number of virtual machines (e.g., a single VM, one hundred VMs, etc.). In the example shown, hypervisor 120 may include an identification component 122, a notification component 124, and a notification response component 126. The components discussed herein are purely logical, and one or more components can be implemented by one or more hardware and/or one or more software modules.

Components 122, 124, and 126 may enable hypervisor 120 to communicate with virtual machine 110 regarding a hardware event to avoid VM exit events. Each of the components may be separated into one or more components or may be included within the same component. Identification component 122 may enable hypervisor 120 to interact with a virtual machine to detect and identify a storage unit (e.g., a memory page) as a candidate memory for use by another process. Notification component 124 may enable hypervisor 120 to receive memory location of a candidate memory, block access to the candidate memory, and prepare and send a first message to the virtual machine 110. The first message notifies the virtual machine to stop attempting to access the candidate memory. Notification response component 126 may enable hypervisor 120 to detect a second message generated by a virtual machine and, in response to the second notification message, make a memory page in the second message accessible by guest application running on the virtual machine. The second message may indicate that access to a memory page involved in a page fault with virtual machine is desired and notify the hypervisor to make the memory page accessible by guest application running on the virtual machine.

Transition event 128 may represent the transition of a processor 132A between executing virtual machine 110 and executing hypervisor 120. Transition event 128 may be caused by an operation of virtual machine 110, guest operating system 111, hypervisor 120, hardware resources 130, or a combination thereof. In one example, guest operating system 111 may execute an instruction that involuntarily transitions execution from the computing process of guest operating system 111 to the computing process of hypervisor 120. The involuntary transition may occur when the underlying hardware is unable to process the instruction and may transition to the hypervisor so that the hypervisor can perform an action in response to the instruction.

Hardware resources 130 may provide hardware features for performing computing tasks. In one example, one or more of the hardware resources may correspond to a physical device of computing system 100. In another example, one or more of the hardware resources may be provided by hardware emulation and the corresponding physical device may be absent from computing system 100. For example, computing system 100 may be a server machine that does not include a graphics device (e.g., graphics card) or includes a graphics device that does not support a particular hardware feature. Hypervisor 120 may provide the hardware feature of the hardware resource by emulating a portion of the hardware resource (e.g., provide a virtualized graphics device). The emulation of a portion of a hardware resource may be provided by hypervisor 120, virtual machine 110, host operating system (not shown), another hardware resource, or a combination thereof.

In the example shown in FIG. 1, hardware resources 130 may include a processor 132A, a storage device 132B, a network interface device 132C, a graphics device 132D, other physical or emulated devices, or combination thereof. Processor 132A may refer to devices capable of executing instructions encoding arithmetic, logical, or I/O operations. Processor 132A may be a single core processor, which may be capable of executing one instruction at a time (e.g., single pipeline of instructions) or a multi-core processor, which may simultaneously execute multiple instructions. Storage device 132B may include any data storage that is capable of storing digital data, such as physical memory devices including volatile memory devices (e.g., RAM), non-volatile memory devices (e.g., NVRAM), other types of memory devices, or a combination thereof. Storage device 132B may include mass storage devices, such as solid-state storage (e.g., Solid State Drives (SSD)), hard drives, other persistent data storage, or a combination thereof. Network interface device 132C may provide access to a network internal to the computing system 100 or external to the computing system 100 (e.g., network 140) and in one example may be a network interface controller (NIC). Graphics device 132D may provide graphics processing for the computing system 100 and/or one or more of the virtual machines 110. One or more of the hardware resources 130 may be combined or consolidated into one or more physical devices or may partially or completely emulated by hypervisor 120 as a virtual device.

Network 140 may be a public network (e.g., the internet), a private network (e.g., a local area network (LAN), wide area network (WAN)), or a combination thereof. In one example, network 140 may include a wired or a wireless infrastructure, which may be provided by one or more wireless communications systems, such as a wireless fidelity (WiFi) hotspot connected with the network 140 and/or a wireless carrier system that can be implemented using various data processing equipment, communication towers, etc.

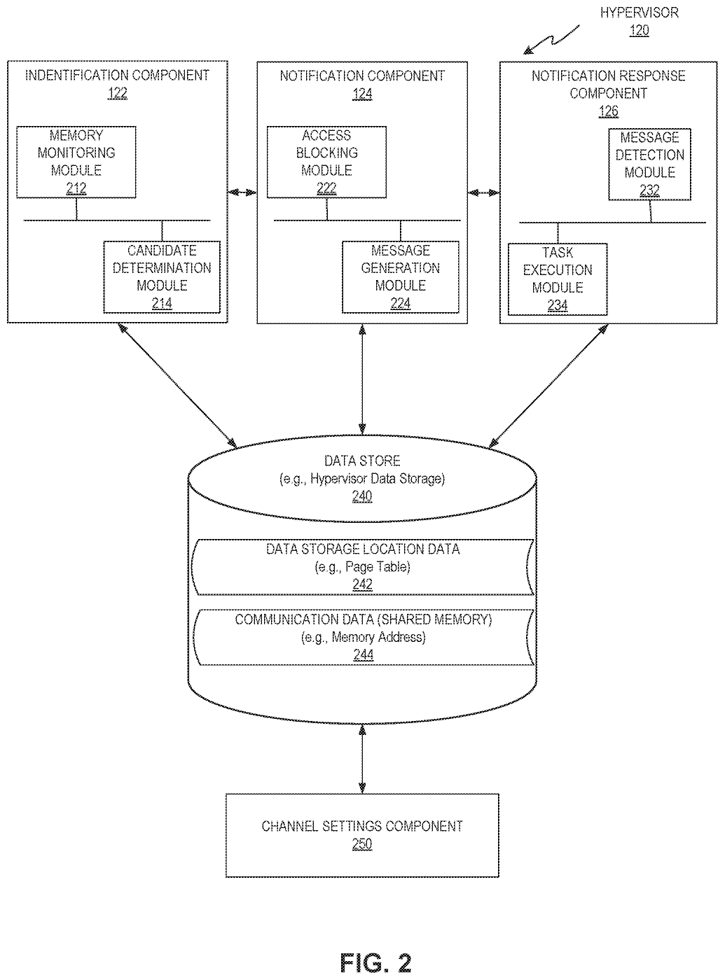

Although not shown in FIG. 1, a channel settings component may be included in virtual machine 110 and/or hypervisor 120. The channel settings component may enable virtual machine 110 and/or hypervisor 120 to determine settings for establishing and operating a communication channel between a virtual machine 110 and hypervisor 120, as discussed in more details with regard to FIG. 2.

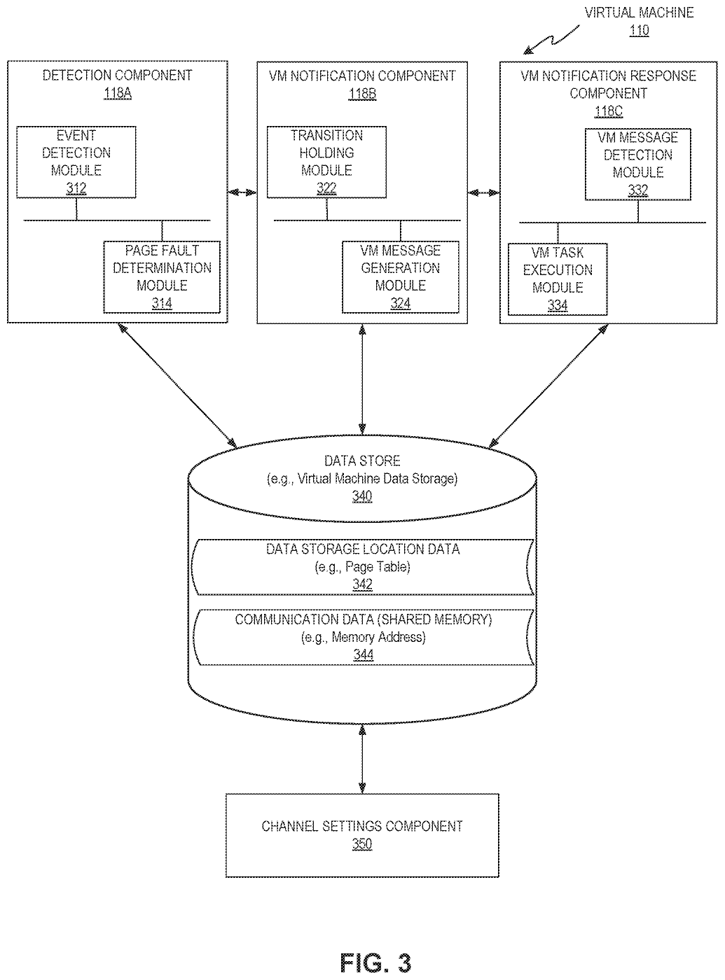

FIG. 2 depicts a block diagram illustrating an exemplary hypervisor 120 that include technology for efficient communication to reduce the transition events between the hypervisor and the virtual machine related to a hardware event (e.g., page fault), in accordance with one or more aspects of the present disclosure. Hypervisor 120 may be the same or similar to hypervisor of FIG. 1 and may include an identification component 122, a notification component 124, a notification response component 126, and a data store 240. Hypervisor 120 may further include a channel settings component 250. FIG. 3 depicts a block diagram illustrating an exemplary virtual machine 110 that include technology for effective communication for reducing the transition event between the hypervisor and the virtual machine based on a hardware event (e.g., page fault), in accordance with one or more aspects of the present disclosure. Virtual machine 110 may be the same or similar to virtual machine of FIG. 1 and may include a detection component 118A, a VM notification component 118B, a VM notification response component 118C, and a data store 340. Virtual machine 110 may further include a channel settings component 350.

FIGS. 2 and 3 are described below together. The components and modules discussed herein may be performed by any portion of hypervisor 120 or a host operating system, by any portion of virtual machine 110 or a guest operating system, by other portion of a computing system, or a combination thereof. More or less components or modules may be included without loss of generality. For example, two or more of the components may be combined into a single component, or features of a component may be divided into two or more components. In one implementation, one or more of the components may reside on different computing devices (e.g., a client device and a server device). For one example, the channel setting component 250 in FIG. 2 and the channel setting component 350 in FIG. 3 may be the same.

Referring now to FIGS. 2 and 3, channel settings component 250 or 350 may enable hypervisor 120 or virtual machine 110 to determine settings for establishing and operating a communication channel between virtual machine 110 and hypervisor 120. Settings of the channel may relate to the memory locations being accessed, the processes and instructions being executed, the details of the hardware event, the computing tasks being performed, other settings, or a combination thereof. The channel settings may be selected by a process of the virtual machine or hypervisor before, during, or after design, development, compiling, linking, installation, testing, deployment, loading, initialization, runtime, other point in time, or a combination thereof. One or more of the channel settings may be selected by a compiler, linker, installer, virtual machine, hypervisor, host operating system, computer program, administrator, programmer, other entity, or a combination thereof. In one example, one or more of the channel settings may be determined by the virtual machine and provided to the hypervisor or determined by the hypervisor and provided to the virtual machine. In another example, one or more of the channel settings may negotiated and agreed upon by one or more virtual machines, hypervisors, or a combination thereof.

The channel settings component 250 or 350 may enable hypervisor 120 or virtual machine 110 to determine the shared memory 244 or 344 that will be used to store the memory location used by the message. The shared memory 244 or 344 may be a shared memory that can be updated by the virtual machine or the hypervisor. The shared memory 244 or 344 may be any physical, logical, or virtual memory at any level of the memory hierarchy (e.g., L1-L3 Cache, main memory, auxiliary memory, memory swap space, etc.). For one example, the shared memory 244 in FIG. 2 and the shared memory 344 in FIG. 3 may be the same.

Identification component 122 may enable hypervisor 120 to interact with a virtual machine to detect and identify a storage unit (e.g., a memory page) as a candidate memory for use by another process. For example, identification component 122 may find that a virtual machine has not accessed a memory page for a time period and mark it as a candidate memory for use by another virtual machine. Identification component 122 may identify a guest memory page identified by a guest memory page address in a guest memory space of a virtual machine managed by the hypervisor. In one example, identification component 122 may include a memory monitoring module 212 and a candidate determination module 214.

Memory monitoring module 212 may monitor a storage region of the data storage and may indicate the state of the storage region. The storage region may include one or more processor registers, portions of memory, portions of a mass storage device, other storage location, or a combination thereof. In one example, memory monitoring module 212 may monitor periodically the storage region of the virtual machines through virtual machines, hypervisors, or a combination thereof. In another example, memory monitoring module 212 may monitor the storage region of the virtual machines upon detecting a presence of a memory modification. The state of the storage region may indicate the time lapses from the last use and may include a state of being used currently, a state of not being used, and the state of not being used may include a state being used recently, and a state of being used remotely. Additional levels for the states with respect to the time lapses after the last use may be added. In one example, memory monitoring module 212 may be associated with one or more virtual or physical processor(s). A virtual or physical processor may monitor the storage region and other processors may modify the storage region as a form of inter-processor communication. Memory monitoring modules 212 may monitor the storage region through part or all of virtual or physical processor(s).

Candidate determination module 214 may enable hypervisor 120 to determine whether the data storage region include a candidate storage for use by another process and identify the candidate storage. In one example, candidate determination module 214 may determine the candidate storage by receiving analyzed information of the data storage region from the virtual machine (e.g., the guest operating system or guest application) and identifying the candidate storage. In another example, candidate determination module 214 may determine the candidate storage without receiving information from the virtual machine. In which case, candidate determination module 214 may determine the candidate storage by analyzing the guest data storage, storage access patterns, other information, or a combination thereof. In either example, candidate determination module 214 may store the location information of the candidate storage as data storage location data 242 in data store 240.

Data store 240 may be any storage portion that is modifiable by hypervisor 120 and may include a storage unit of hypervisor storage. The data storage location data 242 stored within data store 240 may indicate a plurality of data storage locations and each of the plurality of data storage locations may correspond to an instance of the particular instruction within the guest operating system or guest application. In one example, data storage location data 242 may indicate one or more memory locations of a candidate memory that can be provided for a message to be stored in communication data 244. The memory locations may be within a portion of memory that was allocated by the hypervisor to the virtual machine and is managed by the guest operating system. The message may be generated by the notification component 124.

Notification component 124 may enable hypervisor 120 to receive memory location of a candidate memory, block access to the candidate memory, and prepare and send a first message to the virtual machine 110. The first message may indicate that the candidate memory is ready to be used by another process and notifies the virtual machine to stop attempting to access the candidate memory. In one example, notification component 124 may include an access blocking module 222, and a message generation module 224.

Access blocking module 222 may enable hypervisor 120 to receive memory location of the candidate memory and block access to the candidate memory by making the memory location inaccessible by the virtual machine. In one example, access blocking module 222 may modify a page table entry involving the memory location of the candidate memory in a host page table in the data storage location data 242 of the data store 240.

Message generation module 224 may enable hypervisor 120 to configure a shared memory in view of channel settings data and generate the first message and send it to the virtual machine using the shared memory. Message generation module 224 may configure the computer system (e.g., host machine) so the first message is generated when the candidate memory is detected. In one example, the first message may be stored in the communication data 244 of the data store 240. The first message may indicate that a candidate memory is detected and function as a request to the virtual machine for making the candidate memory inaccessible by guest application running on the virtual machine. Message generation module 224 may generate the first message by writing the guest physical address of the candidate memory into the communication data 244. The first message may include an instruction for requesting the virtual machine to make the guest physical address inaccessible by the guest application.

The communication data 244 may be in a form of list or any applicable data structure. In one example, message generation module 224 may enable hypervisor 120 to configure one or more layers of the memory hierarchy in view of channel settings data for the communication between the hypervisor and the virtual machine to store the communication data 244. The memory hierarchy may have multiple layers (e.g., multiple levels) and may include one or more layers for guest virtual memory, guest physical memory (e.g., guest main memory), guest processor registers (e.g., virtual CPU registers), hypervisor memory (e.g., hypervisor virtual/physical memory), host physical memory (e.g., host main memory), physical processor registers (e.g., CPU registers), other data storage layer, or a combination thereof.

Referring now to FIG. 3, VM notification response component 118C may enable the virtual machine 110 to detect the first message provided by the hypervisor 120 (e.g., the message generation module 224) and, in response to the first notification message, make the candidate memory inaccessible by the guest application running on the virtual machine 110. In one example, VM notification response component 118C may include a VM message detection module 332, and a VM task execution module 234.

VM Message detection module 332 may enable the virtual machine 110 to detect the first message provided by the hypervisor 120. In one example, the first message may be stored in communication data 344 of the data store 340, and VM message detection module 332 may detect the first message by monitoring the communication data 344 and identifying the first message when a new message is generated by the hypervisor 120. In another example, VM message detection module 332 may inspect the communication data 344 of the data store 340 to identify a message indication of the hypervisor 120. The message indication may be in the form of identification data that identifies a message or may include a pointer that points to the identification data.

VM task execution module 234 may enable the virtual machine 110 to perform a computing task responsive to the first message. The computing task may be any task that benefits the virtual machine and may be different from managing the loading of data from backing store. In one example, the computing task performed by the virtual machine may involve making the candidate memory inaccessible by the guest application running on the virtual machine. The virtual machine 110 may unmap the candidate memory from the guest application. The upmapping may be performed by creating or modifying a page table entry in the guest page table. In one example, VM task execution module 234 may create or modify a page table entry in the guest page table in data storage location data 342 of the date store 340 to make the guest physical address of the candidate memory referred in the first message inaccessible to the guest application. The data that indicates the computing task to be performed may be stored in data storage 340 as task data (not shown). Task data may include executable data (e.g., machine code, operations, opcodes instructions, commands), informational data (e.g., parameter values, user credentials, configuration data, settings), other data, or a combination thereof.

Thereafter, a hardware event (e.g., page fault) may be triggered if the guest application running on the virtual machine attempts to access the inaccessible memory page (i.e., candidate memory). Under the standard operation, the inaccessibility of the candidate memory from the guest application may trigger the page fault with hypervisor because of the ummap in the host page table, which may further trigger a transition event (e.g., VM Exit). However, in the instant invention, the inaccessibility of the memory page from the guest application may trigger the page fault with the virtual machine because of the unmap in the guest page table. The page fault with virtual machine is beneficial compared to the page fault with hypervisor in that it involves less operations and enhances the performance efficiency of the computing system. In the example explained herein, the correction of the page fault described below may occur before occurrence of a transition event (e.g., VM Exit).

Detection component 118A may detect the occurrence of a hardware event for data storage and determine whether the hardware event includes a page fault with virtual machine caused by the access attempt to the memory page from the guest application. In one example, detection component 118A may include an event detection module 312, and a page fault determination module 314.

Event detection module 312 may detect the occurrence of hardware events for a region of storage (e.g., range of storage units). Detecting the hardware event may involve detecting a fault, an exception, an interrupt, other signal, or a combination thereof that is initiated by a hardware device. The hardware event may correspond to a particular storage unit and may identify the storage unit using one or more virtualized addresses. In one example, the hardware event may be a page fault of a processing thread. The page fault may be encountered in response to the processing thread attempting to access a storage unit in a virtualized address space (e.g., virtual memory) that does not currently reside in physical memory.

Page fault determination module 314 may enable the virtual machine to determine whether the detected hardware event includes a page fault with virtual machine. Page fault determination module 314 may enable the virtual machine to inspect the hardware events to identify a page fault with virtual machine. The page fault with virtual machine may correspond to a memory page that is upmapped with a guest memory that does not reside in physical memory. The page fault with virtual machine may be encountered in response to a processing thread attempting to access data storage that has been unmapped to a storage unit in a virtualized address space (e.g., virtual memory) that does not currently reside in physical memory.

VM notification component 118B may enable virtual machine 110 to receive information of the memory page involved in the page fault with virtual machine and generate a second message to the hypervisor 120. The second message may indicate that access to the memory page involved in the page fault with virtual machine is desired and notify the hypervisor to make the memory page accessible by guest application running on the virtual machine. In one example, VM notification component 118B may include a transition holding module 322, and a VM message generation module 324.

Transition holding module 322 may enable virtual machine 110 to postpone an execution mode transition that is supported to be initiated by the detection of page fault. The execution mode transition described herein refers to a transition of execution between a hypervisor and a virtual machine managed by the hypervisor (e.g., via VM Exit, VM Enter, or VM Resume). In one example, virtual machine 110 may postpone the execution mode transition by sending a request to the hypervisor of waiting for a particular time period before handing the page fault. In another example, virtual machine 110 may postpone the execution mode transition by waiting for a particular time period after the detection of page fault.

VM message generation module 324 may enable virtual machine 110 to configure a shared memory in view of channel settings data and generate the second message and send it to the hypervisor using the shared memory. VM message generation module 324 may configure the computer system (e.g., host machine) so the second message is generated when the page fault with virtual machine is detected. In one example, the second message may be stored in the communication data 344 of the data store 340. The second message may indicate that a page fault with virtual machine is detected and function as a request to the hypervisor for making the memory page involved in the page fault with virtual machine accessible by guest application running on the virtual machine instead of a execution mode transition from virtual machine to hypervisor. VM message generation module 324 may generate the second message by writing the guest physical address of the memory page into the communication data 344.

The communication data 344 may be in a form of list or any applicable data structure. In one example, VM message generation module 324 may enable virtual machine 110 to configure one or more layers of the memory hierarchy in view of channel settings data for the communication between the hypervisor and the virtual machine. The memory hierarchy may have multiple layers (e.g., multiple levels) and may include one or more layers for guest virtual memory, guest physical memory (e.g., guest main memory), guest processor registers (e.g., virtual CPU registers), hypervisor memory (e.g., hypervisor virtual/physical memory), host physical memory (e.g., host main memory), physical processor registers (e.g., CPU registers), other data storage layer, or a combination thereof.

Referring now to FIG. 2, notification response component 126 may enable hypervisor 120 to detect the second message generated by a virtual machine and, in response to the second notification message, make the memory page in the second message accessible by guest application running on the virtual machine. The second message may indicate that access to a memory page involved in a page fault with virtual machine is desired and notify the hypervisor to make the memory page accessible by guest application running on the virtual machine. In one example, notification response component 126 may include a message detection module 232, and a task execution module 234.

Message detection module 232 may enable the hypervisor 120 to detect the second message generated by the virtual machine 110. In one example, the second message may be stored in communication data 244 of the data store 240, and message detection module 232 may detect the second message by monitoring the communication data 244 and identifying the second message when a new message is generated by the virtual machine 110. In another example, message detection module 232 may inspect the communication data 244 of the data store 240 to identify a message indication of the virtual machine 110. The message indication may be in the form of identification data that identifies a message or may include a pointer that points to the identification data.

Task execution module 234 may enable the hypervisor 120 to perform a computing task responsive to the second notification message. The computing task may be any task that benefits the supervisor and may be different from managing the loading of data from backing store. In one example, the computing task performed by the hypervisor may involve mapping a host memory page to a guest memory page. The mapping may be performed by creating or modifying a page table entry in the host page table. In one example, task execution module 234 may create or modify a page table entry in the host page table in data storage location data 242 of the date store 240 to make the memory page referred in the second message accessible by the guest application. The data that indicates the computing task to be performed may be stored in data storage 240 as task data (not shown). Task data may include executable data (e.g., machine code, operations, opcodes instructions, commands), informational data (e.g., parameter values, user credentials, configuration data, settings), other data, or a combination thereof.

Thereafter, referring now to FIG. 3, VM task execution module 334 may enable the virtual machine 110 to make the memory page involved in the page fault with virtual machine accessible by the guest application, and the computing task performed by the virtual machine 110 may involve creating or modifying a page table entry in the guest page table. In one example, VM task execution module 234 may create or modify a page table entry in the guest page table in data storage location data 342 of the date store 340 to make the memory page accessible by the guest application. In such a way, one or more transition events are avoided when a hardware event is detected, enhancing the ability and efficiency of the hypervisor and the virtual machine and improving the virtualization technology.

Optionally, message generation module 224 may enable the hypervisor 120 to generate a third message or remove the first message to request the virtual machine 110 to make the memory page involved in the page fault with virtual machine accessible by guest application. In one example, message generation module 224 may generate the third message by writing the guest physical address of the memory page into the communication data 244. In another example, message generation module 224 may remove the first message by removing the guest physical address of the memory page from the communication data 244.

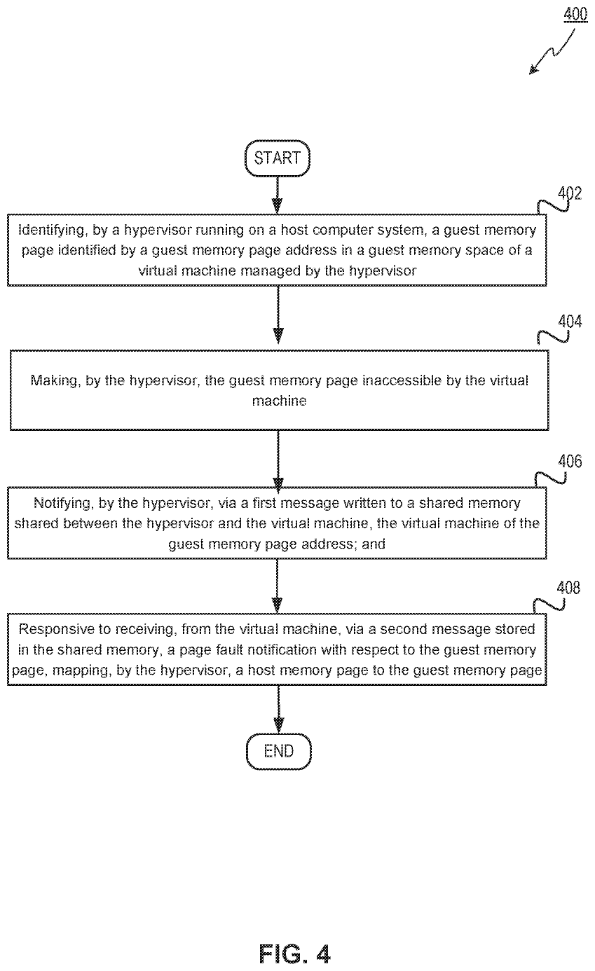

FIG. 4 depicts a flow diagram of an illustrative example of a method 400 that enables a hypervisor to include technology for effective communication for reducing the transition events between the hypervisor and the virtual machine related to a hardware event (e.g., page fault), in accordance with one or more aspects of the present disclosure. Method 400 and each of its individual functions, routines, subroutines, or operations may be performed by one or more processors of a computer device executing the method. In certain implementations, method 400 may be performed by a single processing thread of a hypervisor. Alternatively, methods 400 may be performed by two or more processing threads executing on the computer device and each thread may execute one or more individual functions, routines, subroutines, or operations of the method. In an illustrative example, the processing threads implementing methods 400 may be synchronized (e.g., using critical sections, semaphores, and/or other thread synchronization mechanisms). Alternatively, the processes implementing method 400 may be executed asynchronously with respect to each other.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 400 may be performed by hypervisor 120 of FIGS. 1 and 2 and may begin at block 402.

At block 402, a hypervisor running on a host computer system may identify a guest memory page identified by a guest memory page address in a guest memory space of a virtual machine managed by the hypervisor. Identifying a guest memory page may involve the hypervisor monitoring the data storage of the virtual machine and determining a memory page has not been accessed by the guest (e.g. guest application, guest operating system, virtual processor) for a while that it is a candidate storage for use by another guest (e.g., another guest application, another guest operating system, another virtual processor). In one example, the hypervisor may monitor the data storage by scanning the data storage of the virtual machine(s) periodically. In another example, the hypervisor may monitor the data storage by scanning the data storage of the virtual machine(s) when it detects the presence of a memory modification. In one example, the hypervisor may determine the candidate storage by receiving analyzed information of the data storage region from the virtual machine and identifying the candidate storage. In another example, the hypervisor may determine the candidate storage by analyzing the guest data storage, storage access patterns, other information, or a combination thereof without receiving information from the virtual machine.

At block 404, the hypervisor may make the guest memory page inaccessible by the virtual machine. In one example, the hypervisor may make the guest memory page inaccessible by changing a page table entry involving the guest memory page address in the host page table.

At block 406, the hypervisor may notify the virtual machine of the guest memory page address via a first message written to a shared memory shared between the hypervisor and the virtual machine. The first message may indicate that the candidate memory is ready to be used by another process and notifies the virtual machine to stop attempting to access the candidate memory. In one example, the first message may be generated by writing the guest physical address of the candidate memory into the shared memory. In another example, the first message may include an instruction for requesting the virtual machine to make the guest physical address inaccessible by the guest application.

At block 408, the hypervisor may map a host memory page to the guest memory page responsive to receiving, from the virtual machine, via a second message stored in the shared memory, a page fault notification with respect to the guest memory page. The second message may indicate that access to a memory page involved in a page fault with virtual machine is desired and notify the hypervisor to make the memory page accessible by guest application running on the virtual machine. In one example, the hypervisor may create or modify a page table entry in the host page table to make the memory page referred in the second message accessible by the guest application. In one example, the process at block 408 may be performed after or responsive to the process at block 506 as explained below. Responsive to completing the operations described herein above with references to block 408, the method may terminate.

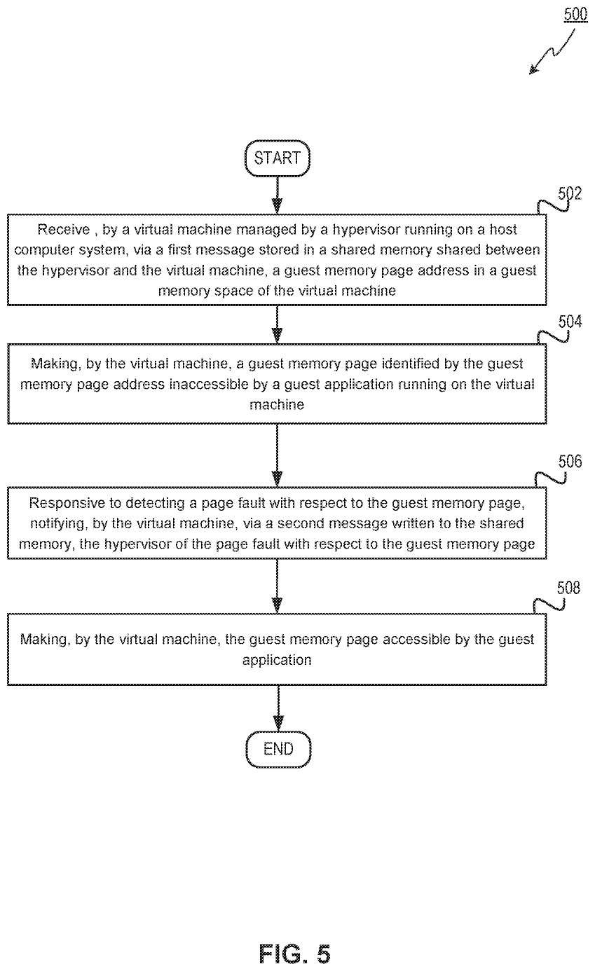

FIG. 5 depicts a flow diagram of an illustrative example of a method 500 that enables a virtual machine to include technology for effective communication for reducing the transition events between the hypervisor and the virtual machine related to a hardware event (e.g., page fault), in accordance with one or more aspects of the present disclosure. Method 500 and each of its individual functions, routines, subroutines, or operations may be performed by one or more processors of a computer device executing the method. In certain implementations, method 500 may be performed by a single processing thread of a virtual machine. Alternatively, methods 500 may be performed by two or more processing threads executing on the computer device and each thread may execute one or more individual functions, routines, subroutines, or operations of the method. In an illustrative example, the processing threads implementing methods 500 may be synchronized (e.g., using critical sections, semaphores, and/or other thread synchronization mechanisms). Alternatively, the processes implementing method 500 may be executed asynchronously with respect to each other.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 500 may be performed by virtual machine 110 of FIGS. 1 and 3 and may begin at block 502.

At block 502, a virtual machine managed by a hypervisor running on a host computer system may receive, via a first message stored in a shared memory shared between the hypervisor and the virtual machine, a guest memory page address in a guest memory space of the virtual machine. The first message may indicate that the guest memory page identified by the guest memory page address is ready to be used by another process and notifies the virtual machine to stop attempting to access the guest memory page. In one example, the virtual machine may receive the first message by monitoring the shared memory and identifying the first message when a new message is generated by the hypervisor. In another example, the virtual machine may inspect the shared memory to identify a message indication of the hypervisor in the form of identification data that identifies a message or with a pointer that points to the identification data. In one example, the process at block 502 may be performed after or responsive to the process at block 406 as explained previously.

At block 504, the virtual machine may make the guest memory page inaccessible by a guest application running on the virtual machine. The virtual machine may unmap the guest memory page from the guest application. The upmapping may be performed by creating or modifying a page table entry in the guest page table. In one example, the virtual machine may may create or modify a page table entry having the guest physical address of the guest memory page in the guest page table.

At block 506, the virtual machine may notify, via a second message written to the shared memory, the hypervisor of the page fault with respect to the guest memory page, responsive to detecting a page fault with respect to the guest memory page. The second message may indicate that access to a memory page involved in a page fault with virtual machine is desired and notify the hypervisor to make the memory page accessible by the guest application running on the virtual machine. The virtual machine may notify the hypervisor of the page fault with respect to the guest memory page by writing the guest physical address of the guest memory page into the shared memory.

At block 508, the virtual machine make the guest memory page accessible by the guest application. The virtual machine may make the guest memory page involved in the page fault accessible by the guest application by creating or modifying a page table entry in the guest page table. In one example, the process at block 508 may be performed after or responsive to the process at block 408 as explained previously. Responsive to completing the operations described herein above with references to block 406, the method may terminate.

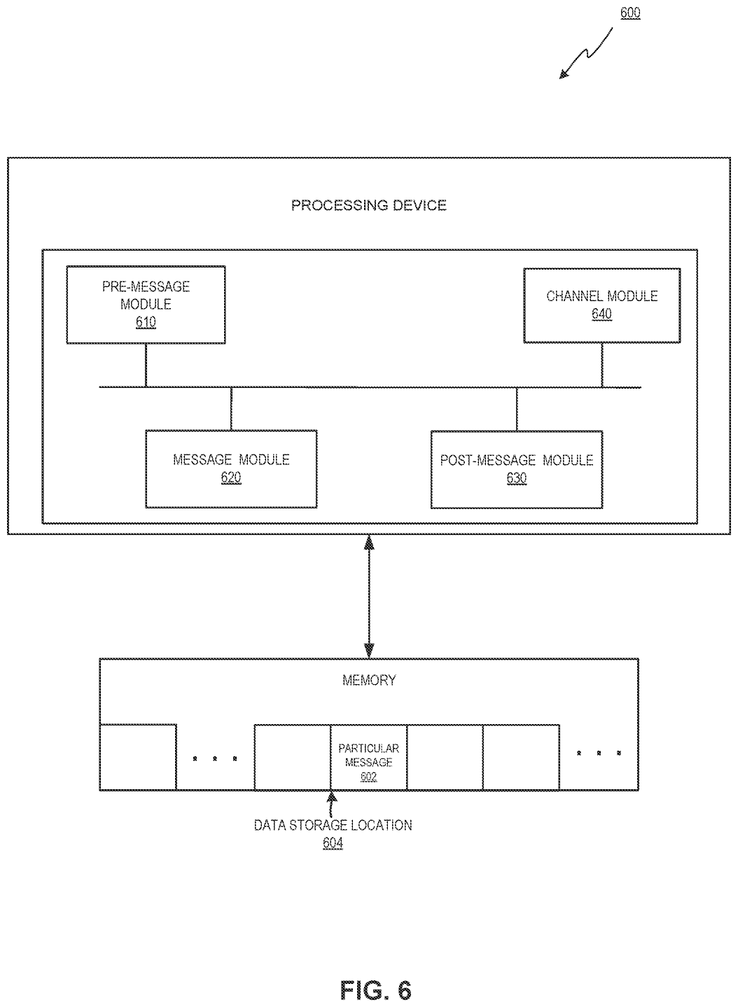

FIG. 6 depicts a block diagram of a computer system 600 operating in accordance with one or more aspects of the present disclosure. Computer system 400 may be the same or similar to computing system 100 of FIG. 1 and may include one or more processing devices and one or more memory devices. In the example shown, computer system 600 may include a pre-message module 610, a message module 620, a post-message module 630, and a channel module 640.

Pre-message module 610 may enable a processing device executing a hypervisor to determine a data storage location for a particular message 602. In one example, determining the data storage location 604 for a particular message 602 may involve the hypervisor identify a candidate memory that has not been accessed by a virtual machine for a while and is ready for use by another computing process. Data storage location 604 may indicate a memory location within memory managed by the hypervisor. In another example, determining the data storage location 604 for a particular message 602 may involve the virtual machine identify a page fault caused by a virtual computing process attempting to access a memory page. Data storage location 604 may indicate a memory location within memory managed by the virtual machine.

Message module 620 may enable the processing device executing the hypervisor to generate messages for communication between a virtual machine executing a guest application and the hypervisor managing the virtual machine regarding a page fault. In one example, message module 620 may enable the hypervisor to notify the virtual machine of the data storage location 604 via a first message written to a shared memory shared between the hypervisor and the virtual machine. The first message may indicate that the candidate memory is ready to be used by another process and notifies the virtual machine to stop attempting to access the candidate memory. In another example, message module 620 may enable the virtual machine to notify the hypervisor the hypervisor of the page fault with respect to the data storage location 604 via a second message written to the shared memory, responsive to detecting a page fault with respect to the data storage location 604.

Post-message module 630 may enable the processing device executing the hypervisor to perform a computing task regarding the data storage location 604 responsive to the particular message 602 to make the data storage accessible or inaccessible. In one example, the computing task may enable the hypervisor to map a guest memory page to a host memory page with respect to the data storage location 604. In another example, the computing task may enable the virtual machine running a guest application to unmap a guest memory page from the guest application with respect to the data storage location 604.

Channel module 640 may enable the processing device executing the hypervisor to execute an operation that corresponds to establishing and operating a communication channel between virtual machine and hypervisor. Settings of the channel may relate to the memory locations being accessed, the processes and instructions being executed, the details of the hardware event, the computing tasks being performed, other settings, or a combination thereof. Channel module 640 may enable hypervisor or virtual machine to determine the shared memory that will be used to store the memory location used by the instruction. The shared memory may be a shared memory that can be updated by the virtual machine or the hypervisor. The shared memory may include one or more processor storage units (e.g., processor registers), memory storage units (e.g., memory pages), disk storage units (e.g., blocks or files), or a combination thereof.

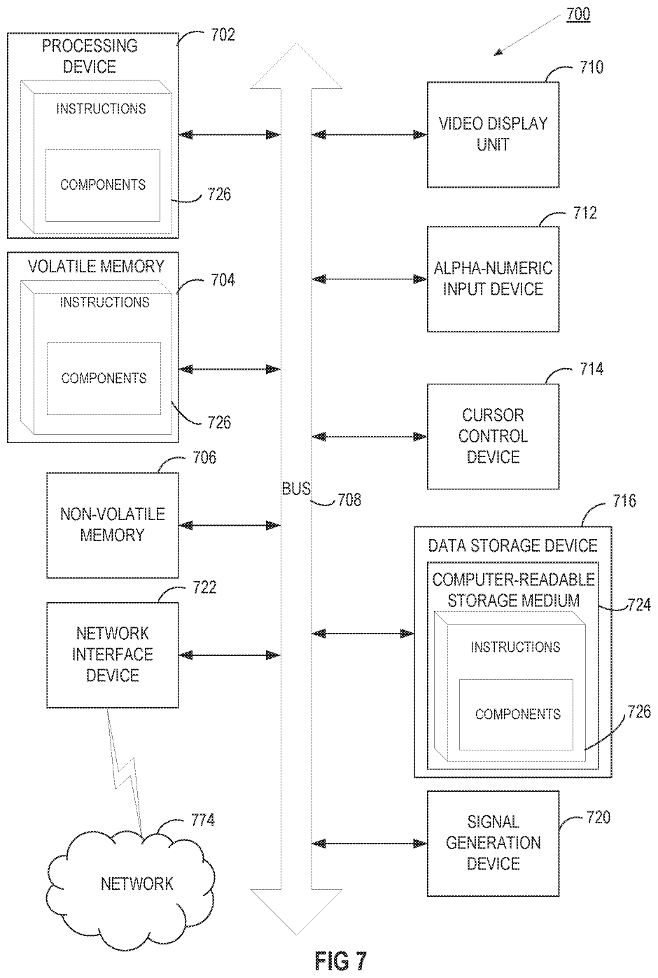

FIG. 7 depicts a block diagram of a computer system operating in accordance with one or more aspects of the present disclosure. In various illustrative examples, computer system 600 may correspond to computing system 100 of FIG. 1. The computer system may be included within a data center that supports virtualization. Virtualization within a data center results in a physical system being virtualized using virtual machines to consolidate the data center infrastructure and increase operational efficiencies. A virtual machine (VM) may be a program-based emulation of computer hardware. For example, the VM may operate based on computer architecture and functions of computer hardware resources associated with hard disks or other such memory. The VM may emulate a physical computing environment, but requests for a hard disk or memory may be managed by a virtualization layer of a computing device to translate these requests to the underlying physical computing hardware resources. This type of virtualization results in multiple VMs sharing physical resources.

In certain implementations, computer system 700 may be connected (e.g., via a network, such as a Local Area Network (LAN), an intranet, an extranet, or the Internet) to other computer systems. Computer system 700 may operate in the capacity of a server or a client computer in a client-server environment, or as a peer computer in a peer-to-peer or distributed network environment. Computer system 700 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 700 may include a processing device 702, a volatile memory 704 (e.g., random access memory (RAM)), a non-volatile memory 706 (e.g., read-only memory (ROM) or electrically-erasable programmable ROM (EEPROM)), and a data storage device 716, which may communicate with each other via a bus 608.

Processing device 702 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 700 may further include a network interface device 722. Computer system 700 also may include a video display unit 710 (e.g., an LCD), an alphanumeric input device 712 (e.g., a keyboard), a cursor control device 714 (e.g., a mouse), and a signal generation device 720.

Data storage device 716 may include a non-transitory computer-readable storage medium 724 on which may store instructions 726 encoding any one or more of the methods or functions described herein, including instructions for implementing methods 400 or 500 and for components of FIGS. 1, 2 and 3.

Instructions 726 may also reside, completely or partially, within volatile memory 704 and/or within processing device 702 during execution thereof by computer system 700, hence, volatile memory 704, and processing device 702 may also constitute machine-readable storage media.

While computer-readable storage medium 724 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer and cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware resources. Further, the methods, components, and features may be implemented in any combination of hardware resources and computer program components, or in computer programs.

Unless specifically stated otherwise, terms such as “initiating,” “transmitting,” “receiving,” “analyzing,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. In addition, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods 400, 500 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
identifying, by a hypervisor running on a host computer system, a guest memory page referenced by a guest memory page address in a guest memory space of a virtual machine managed by the hypervisor;
making the guest memory page inaccessible by the virtual machine;
notifying the virtual machine of the guest memory page address; and
responsive to receiving, from the virtual machine, a page fault notification with respect to the guest memory page, mapping a host memory page to the guest memory page.

2. The method of claim 1, wherein notifying the virtual machine of the guest memory page address further comprises notifying, via a message written to a shared memory shared between the hypervisor and the virtual machine, the virtual machine of the guest memory page address.

3. The method of claim 1, further comprising: responsive to making the guest memory page inaccessible, assigning the guest memory page to a second virtual machine managed by the hypervisor.

4. The method of claim 1, further comprising: responsive to mapping the host memory page to the guest memory page, notifying the virtual machine of accessibility of the guest memory page address.

5. The method of claim 1, wherein making the guest memory page inaccessible further comprises modifying a page table entry in a host page table.

6. The method of claim 1, wherein mapping the host memory page to the guest memory page further comprises modifying a page table entry in a host page table.

7. The method of claim 1, wherein notifying the virtual machine of the guest memory page address further comprises having the virtual machine, responsive to receiving the guest memory page address notification, make the guest memory page referenced by the guest memory page address inaccessible by a guest application running on the virtual machine;

8. The method of claim 7, wherein having the virtual machine make the guest memory page inaccessible by the guest application further comprises modifying a page table entry in a guest page table.

9. The method of claim 1, wherein the page fault notification indicates a page fault with respect to the guest memory page and is generated responsive to detecting the page fault by the virtual machine.

10. The method of claim 4, wherein notifying the virtual machine of the accessibility of the guest memory page address further comprises having the virtual machine, responsive to receiving the notification of the accessibility of the guest memory page address, make the guest memory page accessible by the guest application.

11. The method of claim 10, wherein having the virtual machine make the guest memory page accessible by the guest application further comprises modifying a page table entry in a guest page table.

12. A system comprising:
a memory;
a processing device executing a hypervisor and operatively coupled to the memory, the processing device configured to:
identify, by a hypervisor running on a host computer system, a guest memory page identified by a guest memory page address in a guest memory space of a virtual machine managed by the hypervisor;
make, by the hypervisor, the guest memory page inaccessible by the virtual machine;
notify, by the hypervisor, via a first message written to a shared memory shared between the hypervisor and the virtual machine, the virtual machine of the guest memory page address to have the virtual machine make the guest memory page inaccessible by a guest application running on the virtual machine; and
responsive to receiving, from the virtual machine, via a second message written to the shared memory, a notification of a page fault with respect to the guest memory page, map, by the hypervisor, a host memory page to the guest memory page, wherein the notification of the page fault is generated by the virtual machine responsive to detecting the page fault with respect to the guest memory page.

13. The system of claim 12, wherein the processing device is further configured to: responsive to making the guest memory page inaccessible, assign the guest memory page to a second virtual machine managed by the hypervisor.

14. The system of claim 12, wherein the processing device is further configured to: responsive to mapping the host memory page to the guest memory page, notify the virtual machine of accessibility of the guest memory page address.

15. The system of claim 12, wherein the processing device is further configured to: have the virtual machine, responsive to receiving the notification of the accessibility of the guest memory page address, make the guest memory page accessible by the guest application.

16. The system of claim 12, the processing device is further configured to: modify a page table entry in a host page table.

17. The system of claim 12, the processing device is further configured to: modify a page table entry in a guest page table.

18. A non-transitory machine-readable storage medium storing instructions which, when executed, cause a processing device executing a hypervisor to perform operations comprising:
identifying, by the hypervisor, a guest memory page referenced by a guest memory page address in a guest memory space of a virtual machine managed by the hypervisor;
making the guest memory page inaccessible by the virtual machine;
notifying the virtual machine of the guest memory page address; and
responsive to receiving, from the virtual machine, a page fault notification with respect to the guest memory page, mapping a host memory page to the guest memory page.

19. The non-transitory machine-readable storage medium of claim 18, wherein the operations further comprise: responsive to making the guest memory page inaccessible, assigning the guest memory page to a second virtual machine managed by the hypervisor.

20. The non-transitory machine-readable storage medium of claim 18, wherein the operations further comprise: responsive to mapping the host memory page to the guest memory page, notifying the virtual machine of accessibility of the guest memory page address.
